(19) United States
(12) Patent Application Publication
(10) Pub. No.: US 2009/0153662 A1
(43) Pub. Date: Jun. 18, 2009

(54) NIGHT VISION SYSTEM FOR RECORDING AND DISPLAYING A SURROUNDING AREA

(75) Inventors: Heinz-Bernhard Abel, Grossostheim-Pflaumheim (DE); Hubert Adamietz, Kleinostheim (DE); Hans-Peter Kreipe, Dieburg (DE)

Correspondence Address: COHEN, PONTANI, LIEBERMAN & PAVANE LLP, 551 FIFTH AVENUE, SUITE 1210, NEW YORK, NY, 10176, US

(73) Assignee: Siemens Aktiengesellschaft

(21) Appl. No.: 11/505,656

(22) Filed: Aug. 17, 2006

(30) Foreign Application Priority Data
Aug. 31, 2005 (DE) 10 2005 041 535.0

(51) Int. Cl. H04N 7/18; G06K 9/00

(52) U.S. Cl. 348/148; 348/E07.085; 382/104

(57) ABSTRACT

In a night-vision system, an area surrounding a motor vehicle is recorded by a recording apparatus and information about recorded objects is displayed on a display. The recording apparatus has a laser light source and a laser detection apparatus, with the laser light source transmitting laser pulses which scan the area in front of the motor vehicle. The laser detection apparatus uses the laser pulses reflected from objects to detect the position and/or movement direction of the objects. The position of those objects whose position and/or movement direction is relevant for the motor vehicle is displayed in an emphasized form on the display.

### BACKGROUND OF THE INVENTION

The present invention relates to a night-vision system in which a surrounding area is recorded by a recording apparatus and is at least partially displayed by a display. Night-vision systems such as these are known from the prior art, in which infrared cameras are used to record and display the area surrounding the vehicle. In this case, obstructions are displayed in an emphasized form in a system with a range of <80 m. Another system is restricted to illuminating the surrounding area by an infrared headlight, recording the illuminated are using an infrared camera, and displaying the recorded image on a display. A monitoring distance of, for example, approximately 80 m is too little to provide the driver with a sensible warning of approaching obstructions, by object recognition, during off-road driving. When driving at 100 km/h, the distance traveled per second is 27.8 m, and the stopping distance in good road conditions is virtually 90 m (1 second reaction time and 6.5 m/s² braking deceleration). The remaining time period for making a distracted driver aware of an obstruction by means of an assistance system when the obstruction is detected at a maximum range of 150 m is 2 seconds. If the road conditions deteriorate, this time period falls to less than 1 second.

### SUMMARY OF THE INVENTION

The object of the invention is thus to provide a night vision system having a greater range for the night-vision system and to provide better assistance to the driver.

The object is achieved by a night-vision system having a recording apparatus with a laser light source and a laser detection apparatus, the laser light source transmitting laser pulses which scan the area in front of the motor vehicle, and the laser detection apparatus using the laser pulses reflected from the objects to detect the position and/or movement direction of the objects, such that the position of those objects whose position and/or movement direction are/is relevant for the motor vehicle is displayed in an emphasized form on the display. This allows the driver to be warned that a relevant object is located in a specific area. If the display is in the form of a head-up display, it is not essential to have any other recording apparatus. If the recording apparatus has a camera sensitive in the visible spectrum which records a video image displays the recorded video image on the display and the areas to be displayed from the laser detection apparatus and from the camera are made to match, it is possible to provide a better association with the actual position of the object in the area surrounding the vehicle for the vehicle driver.

In one embodiment, the recording apparatus also has an infrared light source and the camera is also sensitive in the near-infrared spectrum. This displays a better image on the display even when the external light is poor and/or the visibility is poor, thus making it possible to provide an even better association with the position of the object for the vehicle driver.

The video image may be analyzed in the areas with relevant objects and the objects classified. This makes it possible on the one hand to process the image data more efficiently and more quickly, while fewer resources are required overall than if the complete video image had to be analyzed.

The objects are preferably emphasized on the basis of their classification, so that the objects can be perceived even more easily than a plurality of different hazard structures by the vehicle drivers. For example, this makes it possible to display people who are on the roadway in an emphasized form. It is likewise possible to provide a specific distinction between adults and children for people who are located alongside the roadway edge, in order to provide the vehicle driver with a special warning when children are present at the roadway edge. If the relevant areas are directionally illuminated with an infrared light source, this makes it possible on the one hand to display the object on the display directly and even better, while simplifying possible classification. This directional illumination can be improved even further by matching it to the speed and/or movement direction of the motor vehicle.

In a further embodiment, the image processing is restricted to the roadway profile in front of the motor vehicle, so that the processing can likewise be carried out more quickly. However, it is also possible to investigate specific objects, such as children, as well in addition to the roadway profile. This roadway profile may be determined, for example, by an optical lane recognition, from a navigation system or from a combination of the speed of travel, the applied steering angle and the lateral acceleration of the motor vehicle. The display may, for example, be a head-up display. In this case, the driver is not distracted from looking at the roadway by looking at the head-up display, and he can look at the roadway and the display at the same time. Instead of the laser light source and the laser detection apparatus, it is also possible to use a radar system, and in this way in some circumstances to provide an even greater monitoring range. If a radar system is additionally provided and its data is additionally processed, in order to improve the detection quality, the range of the night-vision system can be further increased.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention will be explained in more detail in the following text with reference to the figures, in which:

FIG. 1 is a schematic diagram showing imaging area relationships for a camera and the laser detection apparatus on a road;

FIG. 2 is a schematic diagram of an embodiment of a night-vision system according to the present invention; and

FIG. 3 is a view of an image on a display, the image displaying the area surrounding the motor vehicle as shown in FIG. 2.

### DETAILED DESCRIPTION OF THE PRESENTLY PREFERRED EMBODIMENTS

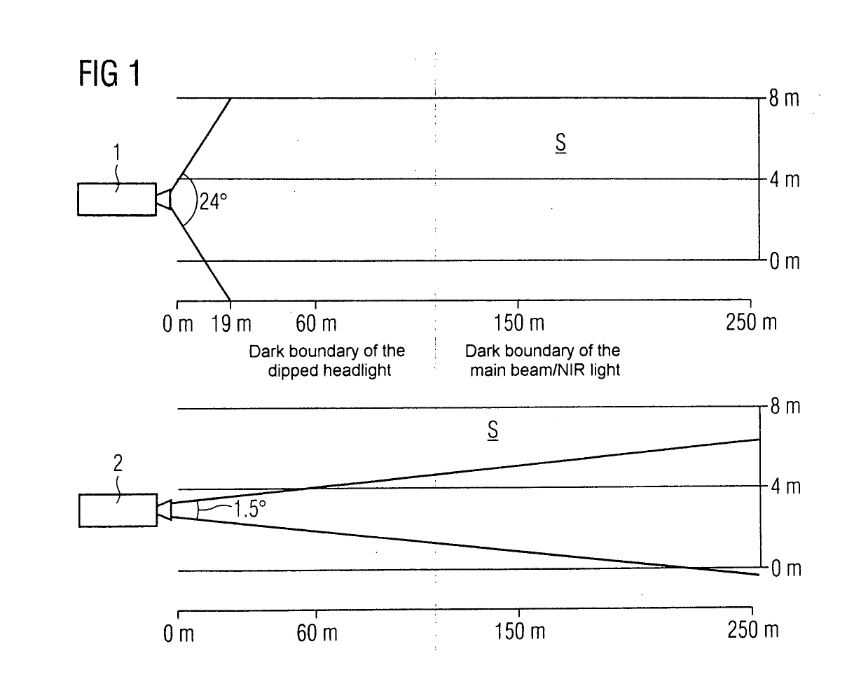

FIG. 1 shows how the imaging relationships for a camera system 1 and a laser detection apparatus 2 or a radar system relate to one another. In this case, it should be noted that horizontal and vertical measurement use different scales. The viewing angle of a camera system should be designed such that the driver can match the displayed scenery well with his actual view through the windshield, that is to say the viewing angle of the camera optics should not correspond to an extreme wide-angle or telescopic lens. The narrow viewing angle of 1.5° of the laser detection apparatus or of the radar system corresponds to that of a telescopic lens. This allows an object to be detected even well beyond the 150 m boundary, and allows its possible position to be available for the object recognition in the image processing.

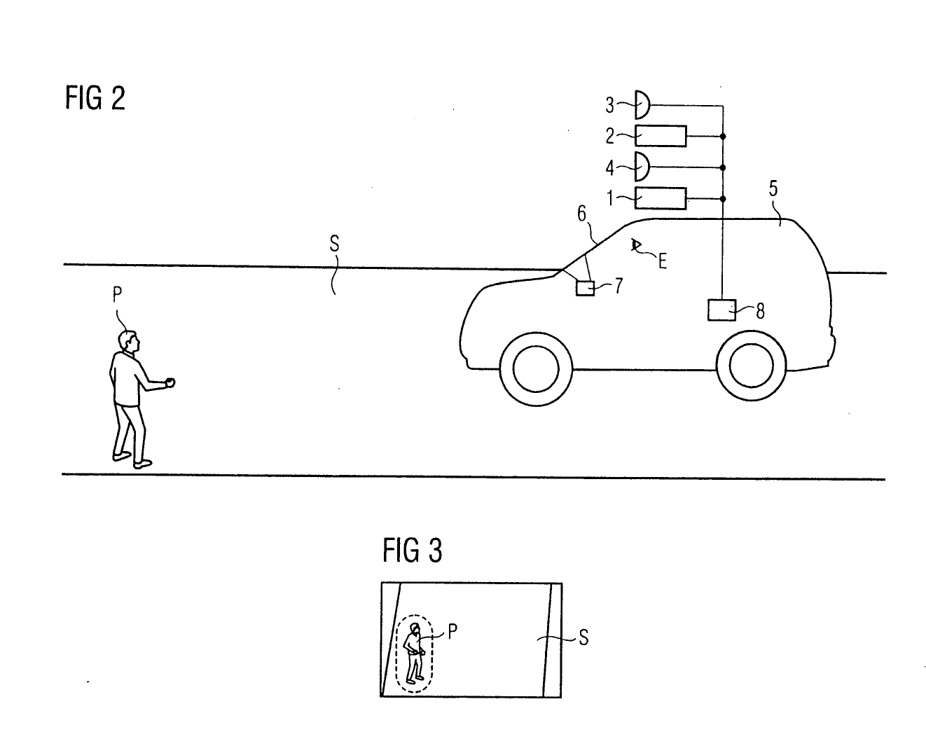

In addition to the camera 1 and the laser detection apparatus 2, FIG. 2 shows that a night vision system includes a laser light source 3, an infrared light source 4, a projection apparatus 7 for projecting an image on a windshield 6 of a motor vehicle 5, and a processing apparatus 8. FIG. 2 also depicts a person P on roadway S and an eye E of a vehicle driver who is in the motor vehicle 5. The laser light source 3 scans the area in front of the motor vehicle 5, and the laser detection apparatus 2 identifies the fact that an object (in this case the person P) is present on the roadway in front of the motor vehicle 5. The processing apparatus 8 receives the position data for the object (person P), and aims the infrared light source 4 at the person P. The camera 1 can thus record the person P well, and the recorded image can be processed and classified in the processing apparatus 8.

The processing apparatus 8 sends the image information and classification information to the projection apparatus 7, which can then project an appropriate image on the windshield 6, so that the driver's eye E can see an image as is illustrated in FIG. 3. The roadway edge of the road S and the person P can be recognized in the image shown in FIG. 3. The person P is displayed in an emphasized form, as represented by the boundary of the contours around the figure P. The emphasis may alternatively or additionally be displayed by a color change, a color modification or a blinking display of the person P, or of the boundary around the person P.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. A night-vision system for a motor vehicle, comprising:
a recording apparatus recording an area surrounding the motor vehicle, said recording apparatus comprising
a signal source and a detection apparatus, said signal source comprising at least one of a laser light source and a radar signal source, said detection apparatus comprising one of a laser detection apparatus and a radar detection apparatus, said signal source scanning an area in front of the motor vehicle by transmitting pulses in the area in front of the motor vehicle, and said detection apparatus detecting reflected ones of the pulses reflected from objects in the area in front of the motor vehicle and using the reflected pulses to detect one of a position and movement direction of the objects,
an infrared light source; and
a camera sensitive in the visible and the near-infrared spectrums and recording a video image;
a processing apparatus determining the ones of the objects for which the one of the position and movement direction is relevant for the motor vehicle, analyzing said video image in areas including the ones of the objects for which the one of the position and movement direction is relevant, and classifying the ones of the objects; and
a display displaying information recorded by said recording apparatus and the video image recorded by said camera, emphasizing on the display a position of the ones of the objects for which the one of the position and movement direction is relevant based on the ones of the objects' classification, and matching the areas to be displayed from said detection apparatus and from said camera.

2. (canceled)

3. (canceled)

4. (canceled)

5. (canceled)

6. The night-vision system of claim 1, wherein said infrared light source directionally illuminates the area or areas including the ones of the objects for which the one of the position and movement direction is relevant.

7. The night-vision system of claim 6, wherein a size of the areas which are directionally illuminated is slaved to a speed and movement direction of the motor vehicle.

8. The night-vision system of claim 1, wherein image processing by said processing apparatus is restricted to the profile of the roadway in front of the motor vehicle.

9. The night-vision system of claim 8, wherein said processing apparatus determines the profile of the roadway using one of optical lane recognition, a navigation system or a combination of speed, steering angle and lateral acceleration of the motor vehicle.

10. The night-vision system of claim 1, wherein said display is a head-up display.

11. The night-vision system of claim 1, wherein said signal source comprises only said radar signal source and said detection apparatus comprises only said radar detection apparatus.

12. The night-vision system of claim 1, wherein said signal source comprises only said laser light source and said detection apparatus comprises only said radar detection apparatus.

13. The night-vision system of claim 1, wherein said signal source comprises both said radar signal source and said laser light source and wherein said detection apparatus comprises both said laser detection apparatus and said radar detection apparatus.
